(19) United States
(12) Patent Application Publication
(10) Pub. No.: US 2024/0089869 A1
(43) Pub. Date: Mar. 14, 2024

(54) SIDELINK REFERENCE SIGNAL REQUEST FIELD FOR CSI AND POSITIONING MEASUREMENT DERIVATION AND PROCEDURES

(71) Applicant: QUALCOMM Incorporated, San Diego, CA (US)

(72) Inventors: Alexandros MANOLAKOS, Escondido, CA (US); Weimin DUAN, San Diego, CA (US); Seyedkianoush HOSSEINI, San Diego, CA (US)

(21) Appl. No.: 18/262,814

(22) PCT Filed: Jan. 25, 2022
(86) PCT No.: PCT/US2022/070343

§ 371 Date: Jul. 25, 2023

(30) Foreign Application Priority Data
Mar. 31, 2021 (GR) 20210100217

(51) Int. Cl. H04W 52/32; H04W 52/24; H04W 52/38

(52) U.S. Cl. CPC H04W 52/325; H04W 52/242; H04W 52/383; H04W 92/18

(57) ABSTRACT

Aspects of the present disclosure provide apparatus, methods, processing systems, and computer readable mediums for sidelink communication between wireless devices. In particular, certain aspects provide for sidelink reference signal (SL-RS) based procedures using an enhanced SL-RS request, such that SL-RS transmission parameters can be more efficiently and smartly signaled to an SL-RS transmitting or receiving UE.

### CROSS-REFERENCE TO RELATED APPLICATIONS

This Application claims the benefit of and priority to Greek Patent Application No. 20210100217, filed Mar. 31, 2021, the entire contents of which are hereby incorporated by reference.

### INTRODUCTION

Aspects of the present disclosure relate to wireless communications, and more particularly, to sidelink communication between wireless devices.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims, which follow, some features will now be discussed briefly. After considering this discussion, and particularly after reading the section entitled “Detailed Description” one will understand how the features of this disclosure provide advantages that include improved sidelink communication techniques.

Certain aspects of the present disclosure are directed to a method for wireless communication by a user equipment (UE). The method generally includes receiving a request in Sidelink Control Information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and transmitting or receiving SL-RS in accordance with the indication.

Certain aspects of the present disclosure are directed to an apparatus for wireless communication by a UE. The apparatus generally includes a memory, and one or more processors coupled to the memory, the one or more processors and the memory being configured to receive a request in Sidelink Control Information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and transmit or receiving SL-RS in accordance with the indication.

Certain aspects of the present disclosure are directed to an apparatus for wireless communication by a UE. The apparatus generally includes means for receiving a request in Sidelink Control Information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and means for transmitting or receiving SL-RS in accordance with the indication.

Certain aspects of the present disclosure are directed to a computer readable medium having instructions stored thereon for receiving a request in Sidelink Control Information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and transmitting or receiving SL-RS in accordance with the indication.

Certain aspects of the present disclosure are directed to a method for wireless communication by a wireless node. The method generally includes sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and receiving, in response to the request, at least one of SL-RS transmitted in accordance with the indication or a report generated based on SL-RS transmitted in accordance with the indication.

Certain aspects of the present disclosure are directed to an apparatus for wireless communication by a wireless node. The apparatus generally includes a memory, and one or more processors coupled to the memory, the one or more processors and the memory being configured to send a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and receive, in response to the request, at least one of SL-RS transmitted in accordance with the indication or a report generated based on SL-RS transmitted in accordance with the indication.

Certain aspects of the present disclosure are directed to an apparatus for wireless communication by a wireless node. The apparatus generally includes means for sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and means for receiving, in response to the request, at least one of SL-RS transmitted in accordance with the indication or a report generated based on SL-RS transmitted in accordance with the indication.

Certain aspects of the present disclosure are directed to a computer readable medium having instructions stored thereon for sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission and receiving, in response to the request, at least one of SL-RS transmitted in accordance with the indication or a report generated based on SL-RS transmitted in accordance with the indication.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIGS. 5A and 5B show diagrammatic representations of example vehicle to everything (V2X) systems, in accordance with certain aspects of the present disclosure.

FIG. 6 illustrates an example of sidelink reference signal (SL-RS) transmissions, in accordance with certain aspects of the present disclosure.

FIGS. 7A-7C illustrate example SL-RS scenarios, in accordance with certain aspects of the present disclosure.

FIGS. 8A-8B illustrate example SL-RS resource allocation, in accordance with certain aspects of the present disclosure.

FIGS. 9A-9D illustrate example SL-RS based positioning scenarios, in accordance with certain aspects of the present disclosure.

FIGS. 10A-10B illustrate example SL-RS based positioning scenarios, in accordance with certain aspects of the present disclosure.

FIG. 11 is a flow diagram illustrating example operations for wireless communication by a user equipment (UE), in accordance with certain aspects of the present disclosure.

FIG. 12 is a flow diagram illustrating example operations for wireless communication by a wireless node, in accordance with certain aspects of the present disclosure.

FIG. 13 is a call flow diagram illustrating an example SL-RS based procedure, in accordance with certain aspects of the present disclosure.

FIGS. 14-15 illustrate examples of content of an SL-RS request, in accordance with certain aspects of the present disclosure.

FIGS. 16-18 are call flow diagrams illustrating example SL-RS based procedures, in accordance with certain aspects of the present disclosure.

FIG. 19 illustrates an example SL-RS based positioning scenario, in accordance with certain aspects of the present disclosure.

FIG. 20 illustrates an example communications devices that may include various components configured to perform operations for the techniques disclosed herein.

FIG. 21 illustrates an example communications devices that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for sidelink communication between wireless devices. In particular, certain aspects provide for sidelink reference signal (SL-RS) based procedures using an enhanced SL-RS request, such that SL-RS transmission parameters can be more efficiently and smartly signaled to an SL-RS transmitting or receiving UE.

The following description provides examples of configurations for SL communication in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

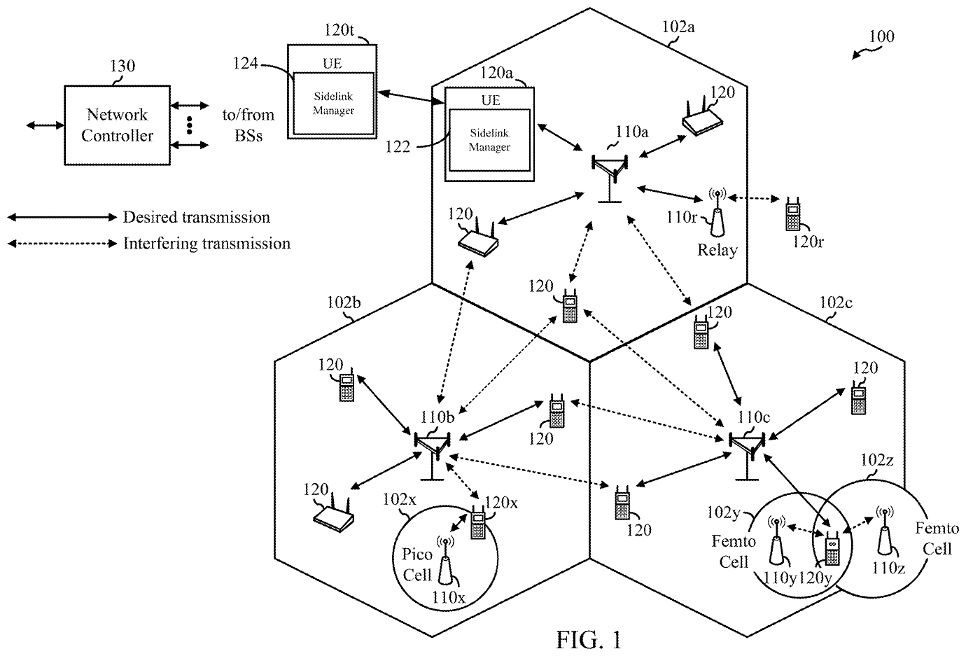

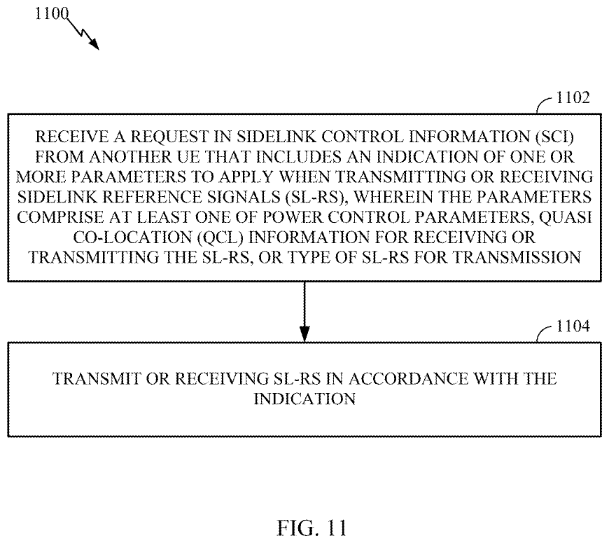

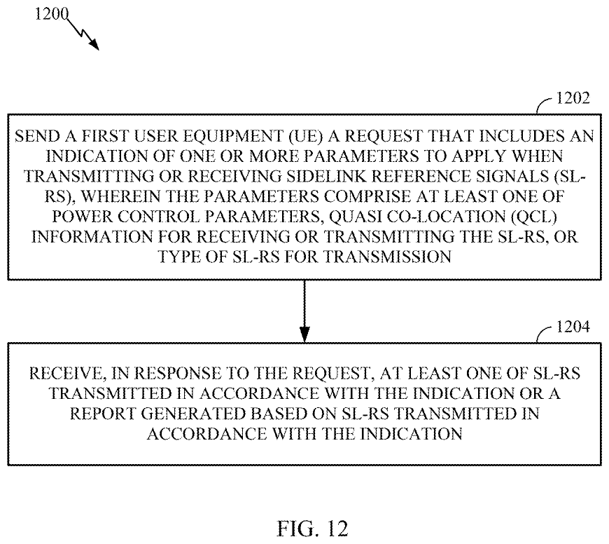

FIG. 1 illustrates an example wireless communication network 100 in which aspects of the present disclosure may be performed. For example, the wireless communication network 100 may include one or more UEs 120 and base stations 110 configured to perform SL-RS based procedures, in accordance with operations 1100 of FIG. 11 and/or 1200 of FIG. 12.

As shown in FIG. 1, the UE 120a includes a Sidelink manager 122. The sidelink manager 122 may be configured to perform one or more operations described in more detail herein. Furthermore, the UE 120t includes a Sidelink manager 124. The sidelink manager 124 may be configured to perform one or more operations described in more detail herein. While not shown, a BS 110a may include similar components configured to perform one or more operations described in more detail herein.

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink (DL) and single-carrier frequency division multiplexing (SC-FDM) on the uplink (UL). OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the UL and DL and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. BSs are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

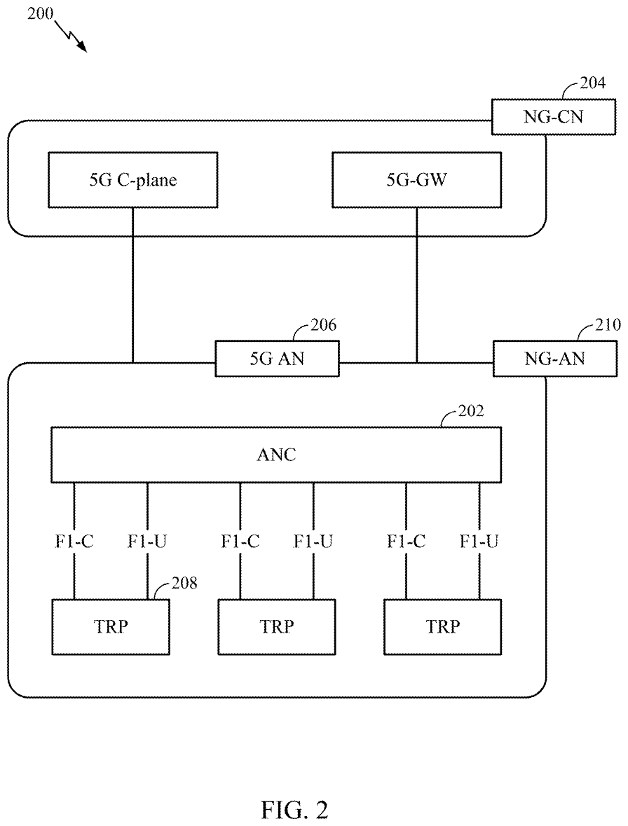

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

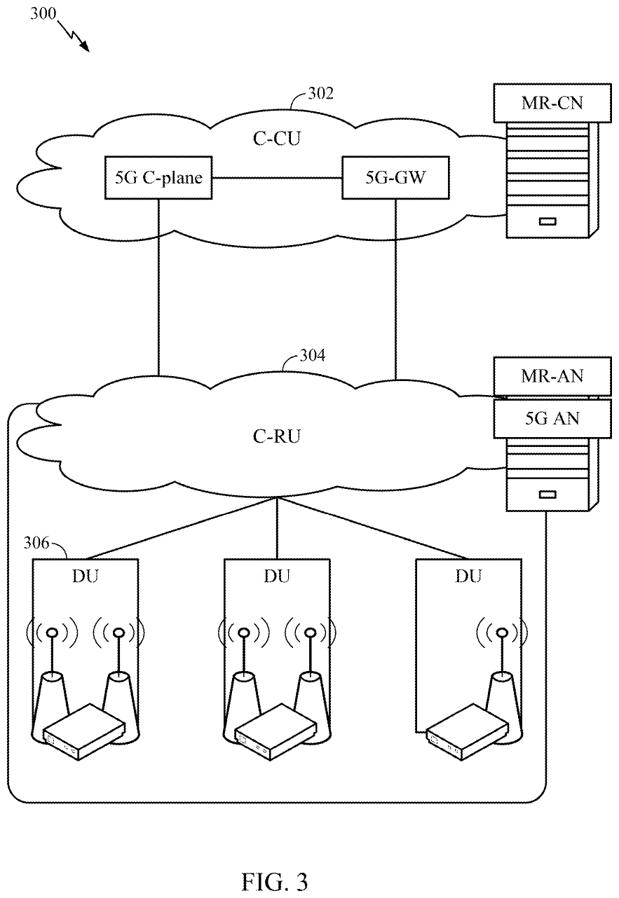

FIG. 3 illustrates an example physical architecture of a distributed RAN 300, in accordance with certain aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

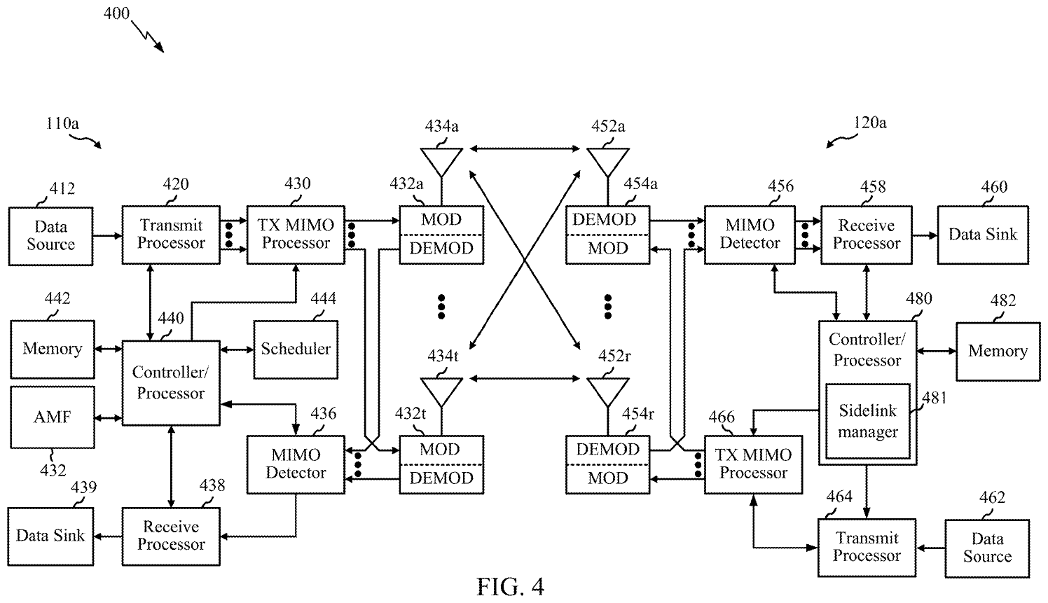

FIG. 4 illustrates example components of BS 110a and UE 120a and/or UE 120t (as depicted in FIG. 1), which may be used to implement aspects of the present disclosure. For example, antennas 452, processors 466, 458, 464, and/or controller/processor 480 of the UE 120a and/or antennas 434, processors 420, 430, 438, and/or controller/processor 440 of the BS 110a may be used to perform the various techniques and methods described herein with reference to FIGS. 11-12.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a DL signal. DL signals from modulators 432a through 432t may be transmitted via the antennas 434a through 434t, respectively.

At the UE 120a, the antennas 452a through 452r may receive the downlink signals from the BS 110a and may provide received signals to the demodulators (DEMODs) in transceivers 454a through 454r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators in transceivers 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the UL, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the BS 110a. At the BS 110a, the UL signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 and/or other processors and modules at the BS 110a may perform or direct the execution of processes for the techniques described herein. As shown in FIG. 2, the controller/processor 480 of the UE 120a has a sidelink manager 481 that may be configured for transmitting a sidelink communication to another UE. Although shown at the controller/processor 480 and controller/processor 440, other components of the UE 120a and BS 110a may be used performing the operations described herein. The memories 442 and 482 may store data and program codes for BS 110a and UE 120a, respectively. A scheduler 444 may schedule UEs for data transmission on the DL, sidelink, and/or UL.

### Example Sidelink Communications

While communication between user equipments (UEs) (e.g., UE 120a and/or UE 120t of FIGS. 1 and 4) and base stations (BSs) (e.g., BSs 110 of FIGS. 1 and 4) may be referred to as the access link, and the access link may be provided via a cellular (Uu) interface, communication between devices may be referred to as the sidelink.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

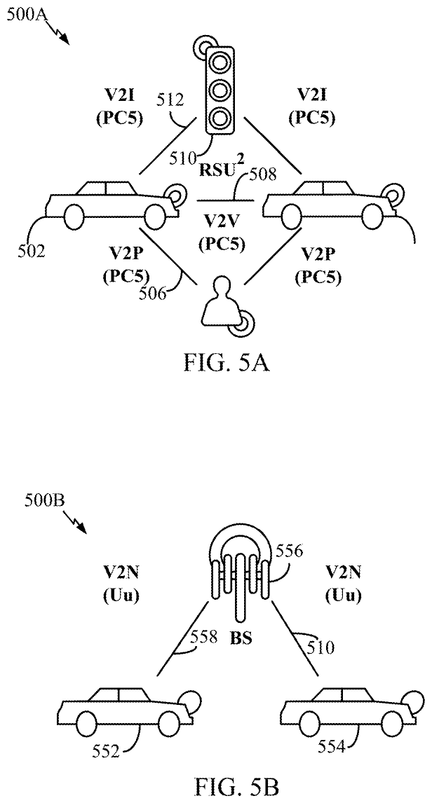

FIGS. 5A and 5B show diagrammatic representations of example vehicle to everything (V2X) systems, in accordance with certain aspects of the present disclosure. For example, the vehicles shown in FIGS. 5A and 5B may communicate via sidelink channels and may perform sidelink channel state information (CSI) reporting as described herein.

V2X systems, provided in FIGS. 5A and 5B provide two complementary transmission modes. A first transmission mode, shown by way of example in FIG. 5A, involves direct communications (for example, also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500A (for example, including vehicle-to-vehicle (V2V) communications) is illustrated with two vehicles 502, 504. The first transmission mode may allow for direct communication between different participants in a given geographic location. As illustrated, a vehicle may have a wireless communication link 506 with an individual (i.e., vehicle to pedestrian (V2P)) (for example, via a UE) through a PC5 interface. Communications between vehicles 502 and 504 may also occur through a PC5 interface 508. In a like manner, communication may occur from a vehicle 502 to other highway components (for example, roadside service unit 510), such as a traffic signal or sign (i.e., vehicle to infrastructure (V2I)) through a PC5 interface 512. With respect to each communication link illustrated in FIG. 5A, two-way communication may take place between elements, therefore each element may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 5B shows a V2X system 500B for communication between a vehicle 552 and a vehicle 554 through a network entity 556. These network communications may occur through discrete nodes, such as a BS (for example, an eNB or gNB), that sends and receives information to and from (for example, relays information between) vehicles 552, 554. The network communications through vehicle to network (V2N) links 558 and 510 may be used, for example, for long range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

As described above, V2V and V2X communications are examples of communications that may be transmitted via a sidelink. Other applications of sidelink communications may include public safety or service announcement communications, communications for proximity services, communications for UE-to-network relaying, device-to-device (D2D) communications, Internet of Everything (IoE) communications, Internet of Things (IoT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes. In some examples, a sidelink signal may be communicated using a licensed spectrum (unlike wireless local area networks (WLANs), which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For the operation regarding PSSCH, a UE performs either transmission or reception in a slot on a carrier. A reservation or allocation of transmission resources for a sidelink transmission is typically made on a sub-channel of a frequency band for a period of a slot. NR sidelink supports for a UE a case where all the symbols in a slot are available for sidelink, as well as another case where only a subset of consecutive symbols in a slot is available for sidelink.

PSFCH may carry acknowledgement (ACK) and/or negative ACK (NACK) from one sidelink UE (e.g., a receiver sidelink UE) to another sidelink UE (e.g., a transmitter sidelink UE).

For sidelink communications, resources may be allocated differently in Mode 1 and in Mode 2. In Mode 1 sidelink communication, the sidelink resources are often scheduled by a gNB. In Mode 2 sidelink communication, the UE may autonomously select sidelink resources from a (pre)configured sidelink resource pool(s) based on the channel sensing mechanism. When the UE is in-coverage, a gNB may be configured to adopt Mode 1 or Mode 2. When the UE is out of coverage, only Mode 2 may be adopted.

### Example Sidelink Reference Signal (SL-RS) Procedures

To improve resource efficiency for both Mode 1 and Mode 2 resource allocation, an enhanced CSI acquisition based on wide-band sidelink reference signals (SL-RS) may be enabled.

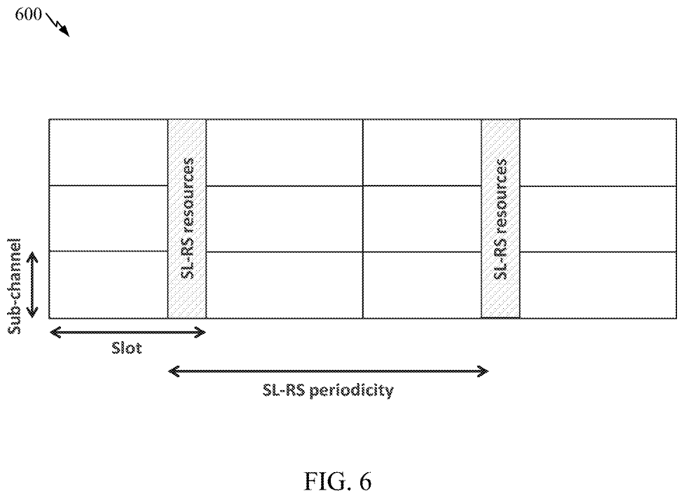

FIG. 6 illustrates an example of such wideband SL-RS, spanning multiple subchannels in the SL resource pool 600. As illustrated in FIG. 6, on a per resource pool basis, a set of resources, either a set of symbols per SL slots or full SL slots, can be set aside for wideband SL-RS. SL RS transmissions may be independent of data transmission.

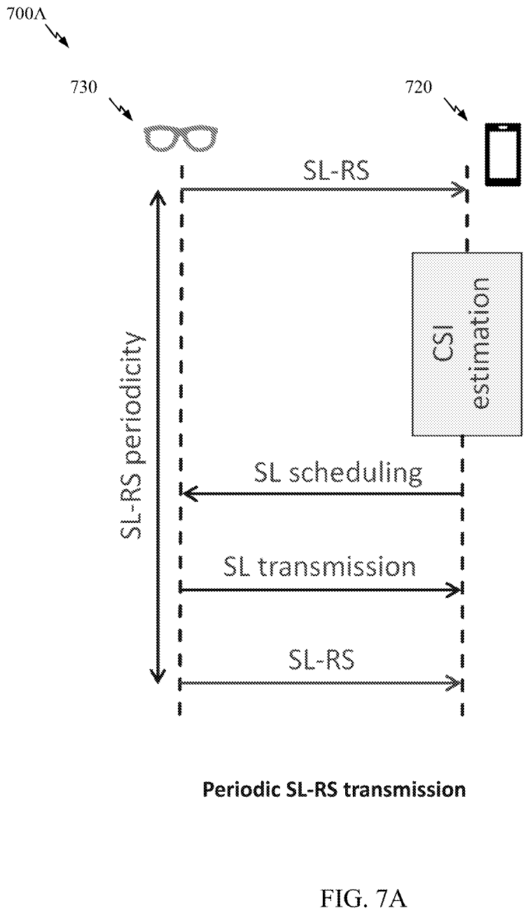

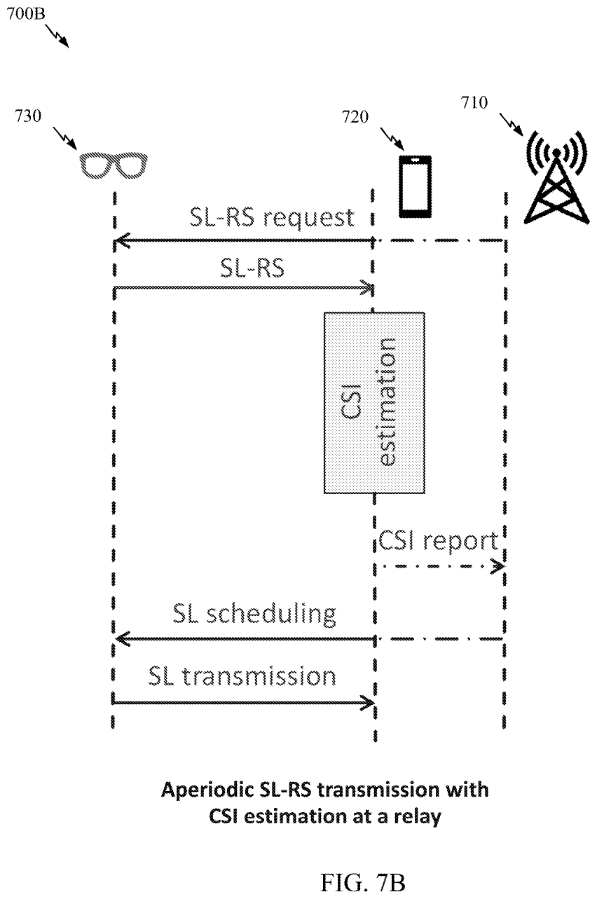

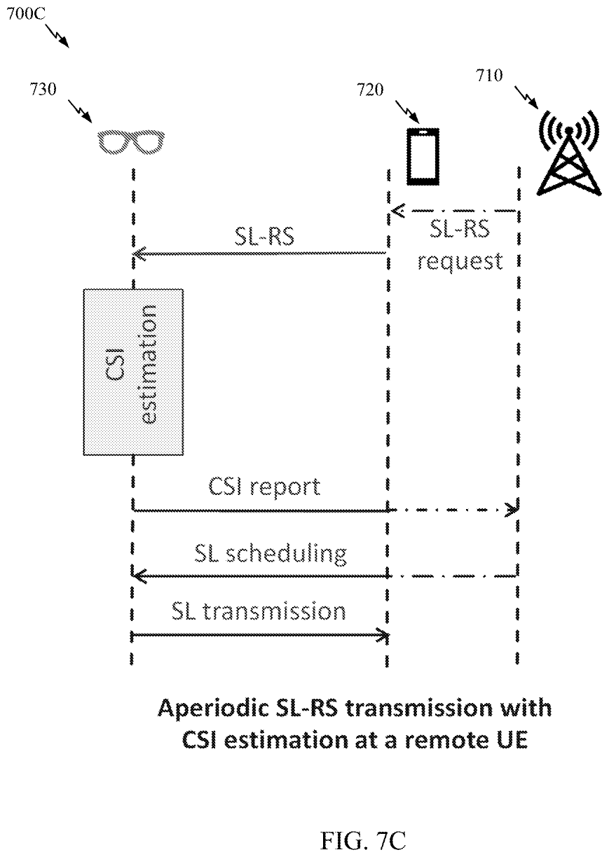

FIGS. 7A-7C illustrate example SL-RS scenarios, in accordance with certain aspects of the present disclosure.

As illustrated in FIG. 7A, SL-RS transmission can be periodic, with a remote UE 730 sending SL-RS according to an SL-periodicity. A primary/relay UE 720 may perform CSI estimation based on the SL-RS and schedule an SL transmission to/from the remote UE 710 accordingly.

As illustrated in FIG. 7B, SL-RS transmission can be aperiodic, for example, based on a request from a gNB 710 or a relay UE 720, or a remote UE 730. In the illustrated example, the SL-RS request is relayed to remote UE 730. SL-RS is then sent by the remote UE 730 to primary/relay UE 720 who performs CSI estimation and sends a CSI report to gNB 710. Based on the report, the gNB may schedule an SL transmission to/from the remote UE 730.

As illustrated in FIG. 7C, SL-RS transmission can be from the relay UE 720 to the remote UE 730. In this case, the remote UE 730 performs CSI estimation and sends a CSI report to relay UE 720, to be relayed to gNB 710. Based on the report, the gNB 710 may schedule an SL transmission to/from the remote UE 730.

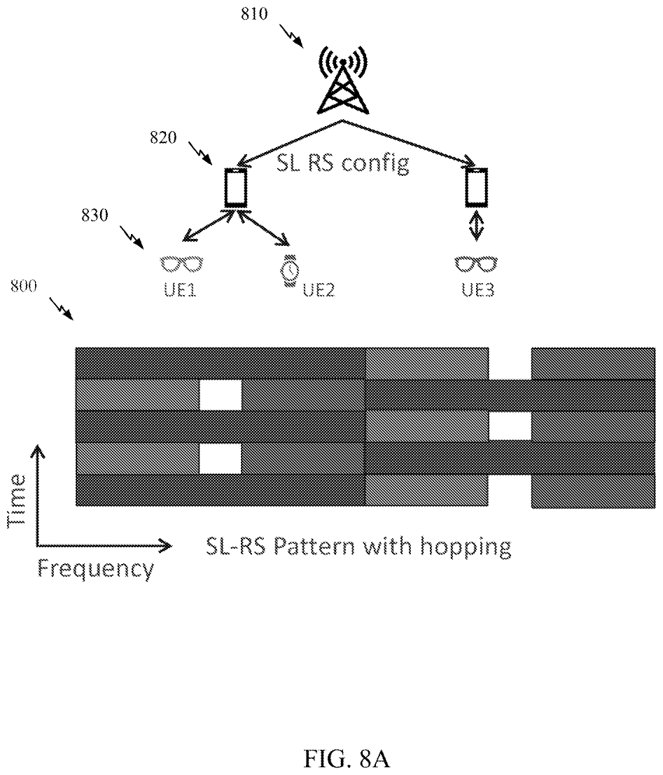

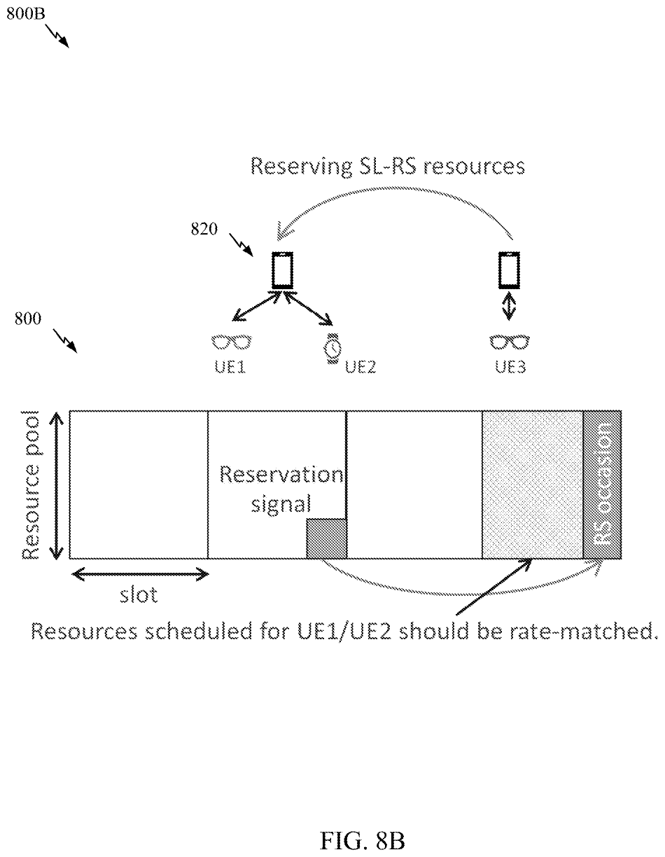

To ensure the quality of SL channel estimation, measures may be taken to avoid collisions on the SL-RS resources to the extent possible. FIG. 8A illustrates one example of SL-RS resource allocation (within a resource pool 800) by a gNB 810 designed to avoid collisions according to one option. As illustrated, the gNB 810 may perform orthogonal allocation across relays to avoid inter-relay interference. In some cases, a frequency hopping pattern may be indicated too allow different devices (e.g., primary/relay UEs 820) to use different frequency resources (frequency diversity) to avoid acquiring “aged” CSI. In some cases, allocation of resources to the remote UEs 830 may be performed by a relay to avoid inter-UE interference. Resource reuse (e.g., where different UEs use the same time and/or frequency resources) across the far away users is possible.

FIG. 8B illustrates an example of SL-RS resource reservation by relay UEs 820 according to another option. As illustrated, a relay UE 820 may reserve SL-RS resources. As noted in FIG. 8B, if some resources are reserved, another UE can schedule its users in the same slot by rate-matching. This approach may lead to improving resource efficiency.

Channel state information (CSI) reporting may be supported for unicast communications. In this case, a UE may trigger a CSI report explicitly in SCI and includes CSI-RS in the associated PSSCH. The receiver UE may report CSI via a medium access control (MAC) control element (MAC-CE). In some cases, the CSI may include 1 bit for rank indicator (RI) and 4 bits for channel quality indicator (CQI).

For sidelink open-loop power control, a UE can be (pre)configured to use downlink pathloss (between TX UE and gNB) only, Sidelink pathloss (between TX UE and RX UE) only, or both downlink pathloss and sidelink pathloss. When both downlink pathloss and sidelink pathloss are used, the minimum of the power values given by open-loop power control based on downlink pathloss and the open-loop power control based on sidelink pathloss may be taken.

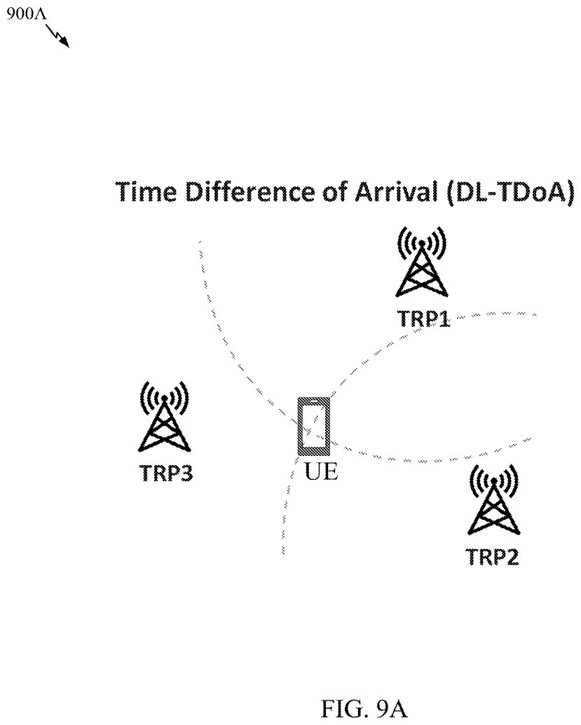

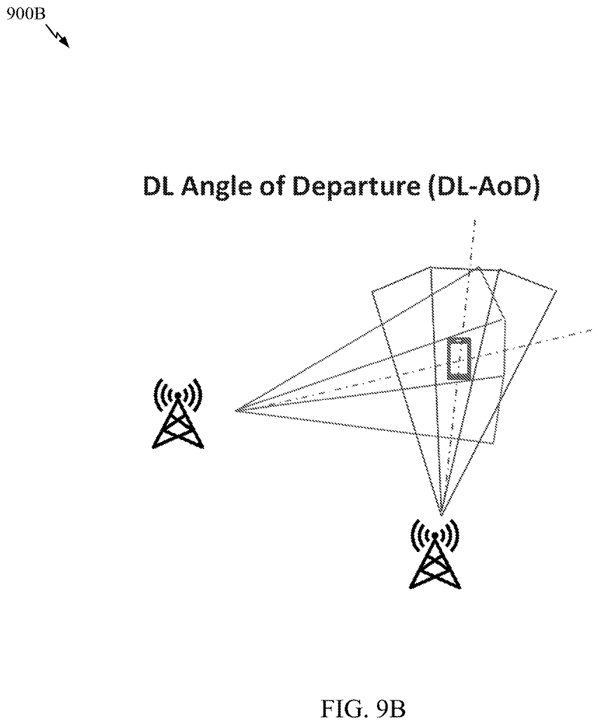

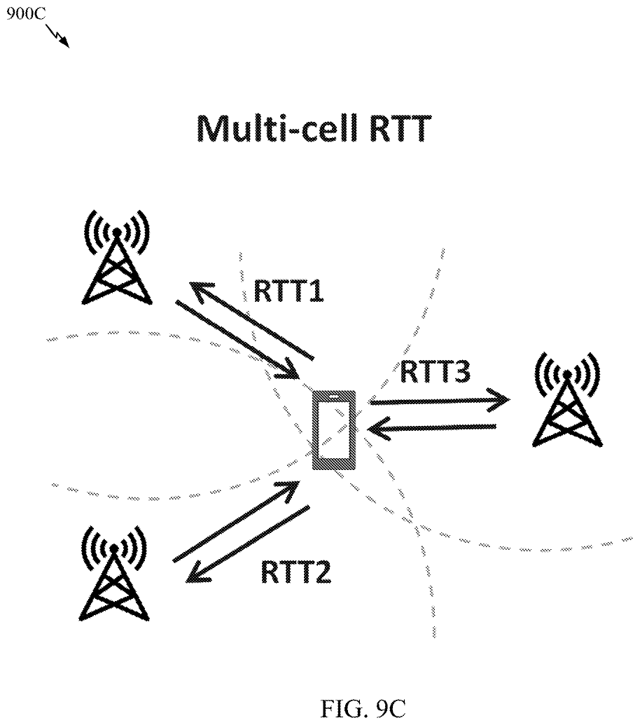

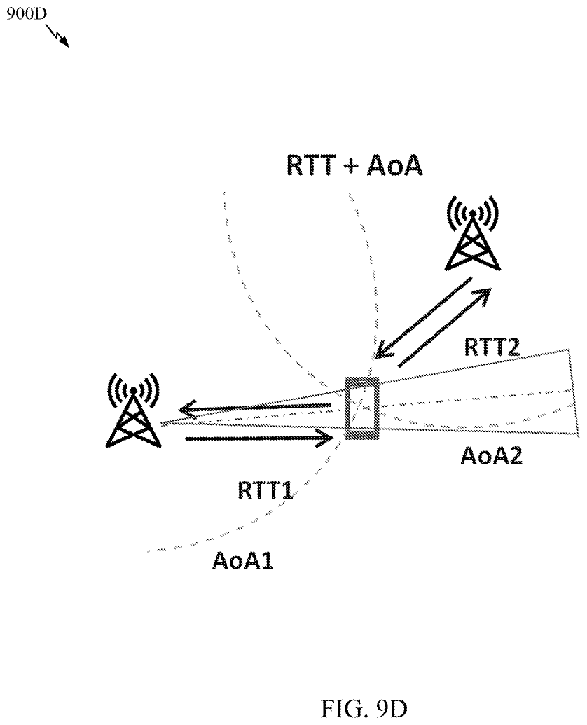

FIGS. 9A-9D illustrate example positioning scenarios, in accordance with certain aspects of the present disclosure, based on different types of measurements. For example, in certain systems (e.g., NR Rel-16), positioning features may be based on (UE-based) downlink time difference of arrival (DL-TDoA) as shown in scenario 900A of FIG. 9A, multi-cell round trip time (RTT) as shown in scenario 900C of FIG. 9C, downlink angle of departure (DL AoD) as shown in scenario 900B of FIG. 9B, uplink angle of arrival (UL AoA) with zenith in addition to azimuth, or a combination of these measurements, such as RTT and AoA as shown in scenario 900D of FIG. 9D.

In certain systems (e.g., NR Rel-17), positioning features may be based on UE-initiated and Network-initiated On-Demand DL-PRS, radio resource control (RRC) Inactive DL-only, UL-only, and/or DL+UL Positioning. Enhancements such as RRC Idle DL measurements for positioning, angle-based methods, aggregation of DL/UL PRS across frequency, and aperiodic (AP) and/or semi-persistent (SP) DL-PRS transmissions may also be supported.

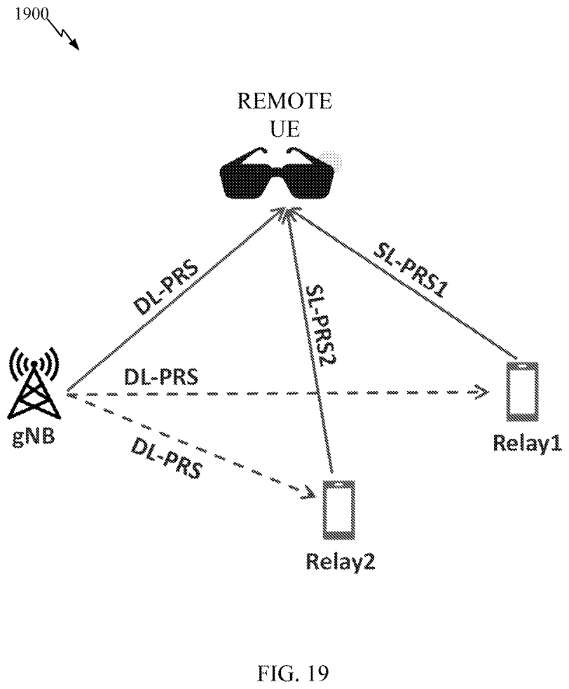

In some cases, positioning may be performed with a single BS and multiple relays, without Uu uplink signaling. Such a scenario is shown in FIG. 19, described in greater detail below, in which a remote UE may receive DL-PRS from a gNB, as well as SL-PRS from multiple relays. In this case, no Uu SRS transmissions may be needed. As a result, the UE may not need to be in UL coverage and loose synchronization may be sufficient.

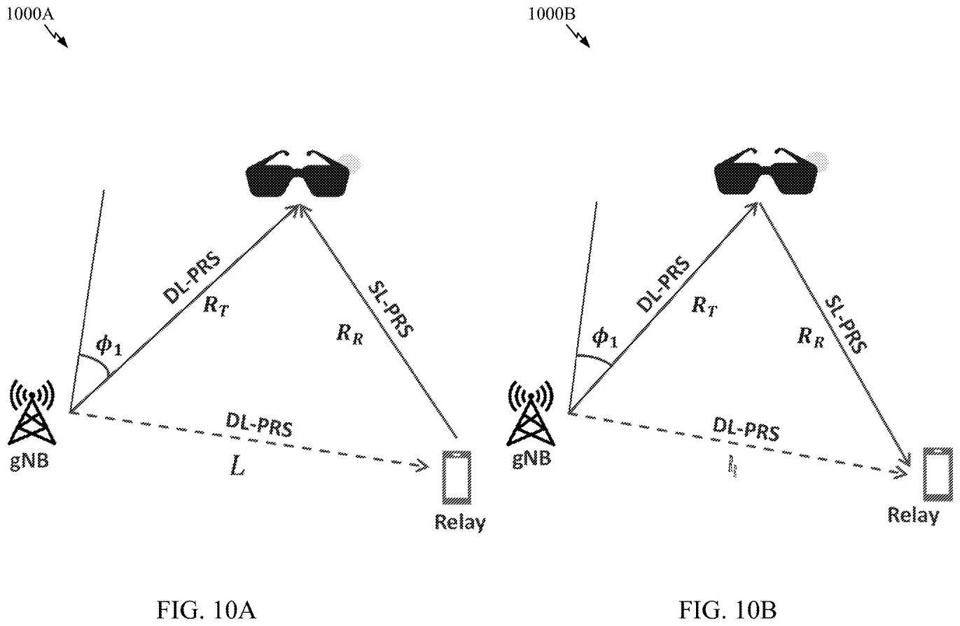

FIGS. 10A and 10B illustrate other examples of positioning, involving a single gNB and single relay UE. In this case, two new measurements (and associated procedures) may be specified. The first measurement is a time difference between reception of DL-RS and transmission of SL RS. The second measurement is a time difference between reception of DL-RS and reception of SL RS. These measurements may be used in a positioning procedure considered a modification of a bi-static radar formulation (which refers to a basic measurement of range made by a radar or sonar system with separated transmitter and receiver, in which the receiver measures the time difference of arrival of the signal from the transmitter directly, and via reflection from the target).

Various power control parameters may be used when transmitting reference signals and in positioning related measurements. Examples of such parameters include indication of a pathloss reference RS (pathlossReferenceRS), alpha, p0, and SRS power control adjustment states used in the following equation:

$${P}_{SRS , b , f , c} ( i , {q}_{s} , l ) = min \{ \begin{matrix}{P}_{CMAX , f , c} ( i ) , \\ {P}_{O\_SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \}$$

Pathloss reference RS refers to a reference signal (e.g. a CSI-RS configuration or an SS block) to be used for SRS path loss estimation. Alpha refers to a value for SRS power control (when the field is absent a UE may applies the value 1. The P0 value for SRS power control is in dBm and, typically, only even values (step size 2) are allowed. SRS-Power Control Adjustment States may indicate whether PUSCH-PC-AdjustmentStates are configured or separate closed loop is configured for SRS. This parameter may be applicable only for uplinks on which UE also transmits PUSCH.

### Example Enhanced SL-RS Request Field for CSI and Positioning Measurement Derivation and Procedures

Aspects of the present disclosure provide apparatus, methods, processing systems, and computer readable mediums for sidelink communication between wireless devices. In particular, certain aspects provide for sidelink reference signal (SL-RS) based procedures using an enhanced SL-RS request, such that SL-RS transmission parameters can be more efficiently and smartly signaled to an SL-RS transmitting or receiving UE.

According to certain aspects, the transmission parameters may include independent power and quasi co-location (QCL) information (e.g., spatial/beam control) information provided in an SL-RS request. This may provide flexibility, for example, allowing SL-RS to be transmitted with different power and/or beams than a PSSCH transmission, which may help increase channel estimation performance, reduce interference, and/or save power.

The ability to use different power control (for data and SL-RS) may also help improve positioning performance, for example, allowing SL-PRS to be transmitted by a device to reach either a nearby device with whom it has an active communication or another device (farther away) to do positioning.

FIG. 11 is a flow diagram illustrating example operations 1100 for wireless communication by a first UE, in accordance with certain aspects of the present disclosure. The operations 1100 may be performed, for example, by a UE (e.g., such as the UE 120a and/or the UE 120t in the wireless communication network 100 in FIG. 1). Operations 1100 may be implemented as software components that are executed and run on one or more processors (e.g., controller/processor 480 and the Sidelink manager 481 of FIG. 4). Further, the transmission and reception of signals by the UE in operations 1100 may be enabled, for example, by one or more antennas. In certain aspects, the transmission and/or reception of signals by the UE may be implemented via a bus interface of one or more processors (e.g., controller/processor 480) obtaining and/or outputting signals.

Operations 1100 begin, at 1102, by receiving a request in sidelink control information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission. At 1104, the first UE transmits or receives SL-RS in accordance with the indication.

FIG. 12 is a flow diagram illustrating example operations 1200 for wireless communication by a wireless node, in accordance with certain aspects of the present disclosure. The operations 1200 may be performed, for example, by a UE (e.g., such as the UE 120a, the UE 120t, and/or BS 110a) in the wireless communication network 100 in FIG. 1). Operations 1200 may be implemented as software components that are executed and run on one or more processors (e.g., controller/processor 480 and the Sidelink manager 481 and/or controller/processor 440 of FIG. 4). Further, the transmission and reception of signals by the UE in operations 1200 may be enabled, for example, by one or more antennas. In certain aspects, the transmission and/or reception of signals by the UE may be implemented via a bus interface of one or more processors (e.g., controller/processor 440 and/or 480) obtaining and/or outputting signals.

Operations 1200 begin, at 1202, by sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission. At 1204, the wireless node receives, in response to the request, at least one of SL-RS transmitted in accordance with the indication or a report generated based on SL-RS transmitted in accordance with the indication.

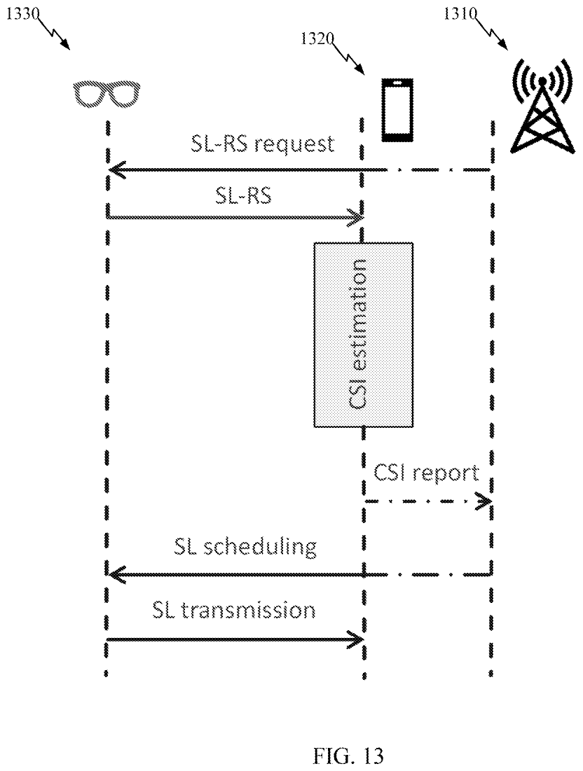

The operations 1100 and 1200 described above and related techniques described herein may be understood with reference to the examples illustrated in FIGS. 13-19.

FIG. 13 is a call flow diagram illustrating an example SL-RS based procedure, in accordance with certain aspects of the present disclosure. As illustrated, a gNB 1310 (via a primary/relay UE 1320) may send an SL-RS request to a remote UE 1330. The SL-RS request may indicate at least one of power control parameters, quasi co-location (QCL) information for receiving or transmitting the SL-RS, or type of SL-RS for transmission.

The remote UE 1330 may transmit SL-RS in accordance with the parameters indicated in the SL-RS request. The primary/relay UE 1320 may then perform CSI estimation and sends a CSI report to gNB 1310. Based on the report, the gNB may schedule an SL transmission to/from the remote UE 1330.

The parameters indicated in the SL-RS request may include one or more of the Power control Configuration parameters (p0, alpha, pathloss reference signal ID, Closed loop adjustment info) or QCL/beam Information (DL RS or SL RS used for beam derivation). As noted above, these parameters may be chosen separately for SL-RS (SL-CSIRS or SL-PRS) from the data channels (PSSCH).

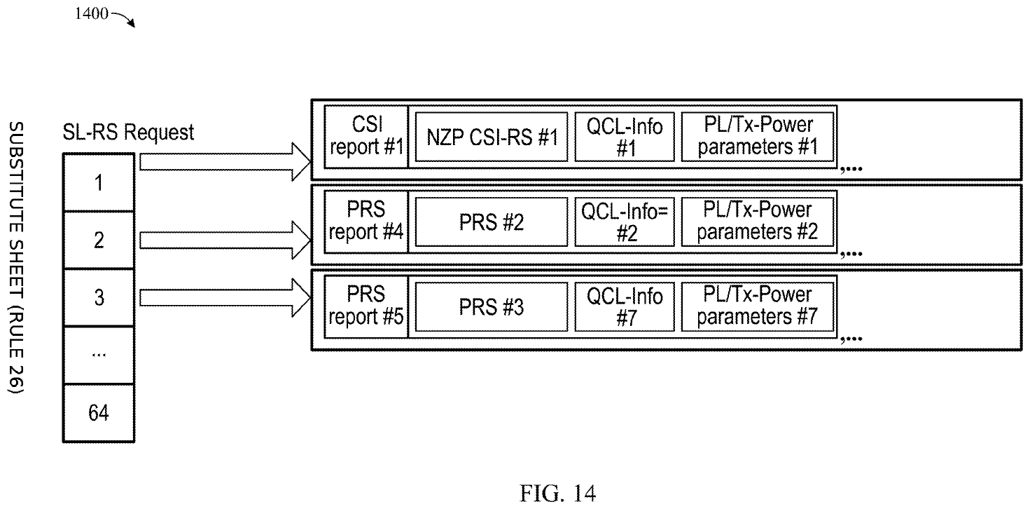

As illustrated in FIG. 14, in some cases, the SL-RS Request may contain a field that picks a SL-RS to be requested for transmission and another field that picks one or more sets of SL-RS transmission (e.g., QCL/power control) parameters values. In the illustrated example, a 6-bit codepoint in the field may select one of 64 sets of parameters. In such cases, the UE may receive higher level signaling indicating the sets of different power control/beam information parameters and then use the codepoint signaled in the SL-RS request to pick one of the sets.

In the example shown in FIG. 14, each codepoint maps to one or more set parameters (report ID, RS ID, QCL ID, Power Control ID/Tx-Power), or a subset/combination of such parameters. If the SL-RS request is for the UE to receive, then the parameters may contain the Tx-Power information (used for the SL-RS transmission received by the UE). If the request is for the UE to transmit, the parameters would contain the Power control parameters, or an ID that picks the parameters from another configured table, that the UE would use when transmitting the SL-RS. QCL-Information may correspond to Spatial Rx/Tx, and/or delay/Doppler information.

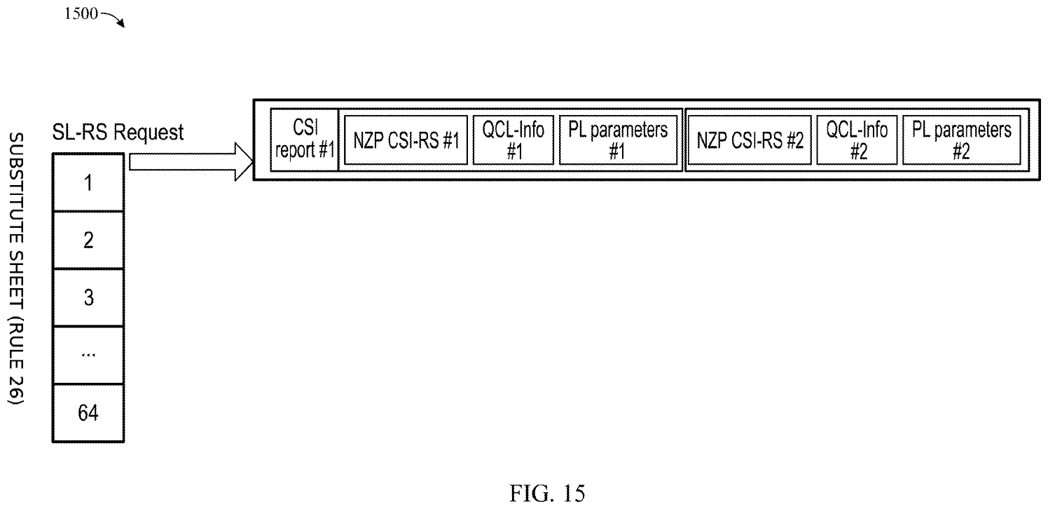

As illustrated in FIG. 15, in some cases joint triggering of multiple SL-RS transmissions may be supported. For example, each codepoint may map to 2 SL-RS parameter sets: one for SL Transmission and one for SL Reception.

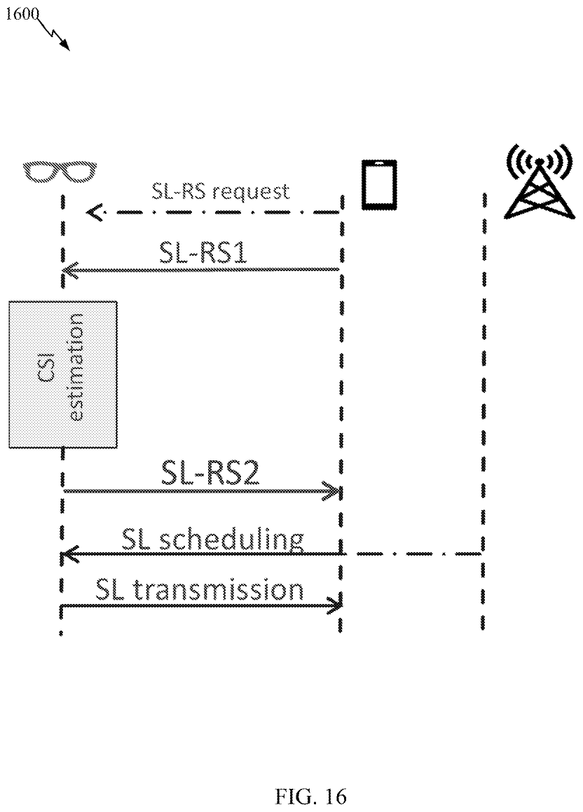

As illustrated in FIG. 16, a first SL-RS (SL-RS1) may be for a remote UE to receive. The remote UE may perform CSI estimation based on this first SL-RS and transmit a second SL-RS (SL-RS2) based on the parameters indicated in the SL-RS request.

As noted above, even for the RS that the UE is to receive, some power control parameters may be included, for example, indicating what is the Tx power of the transmitted RS so that the UE can determine the path-loss (after it performs RSRP measurement: PL=TxPower−RSRP). In some cases, a time-gap between the two SL-RS transmissions may be configured, chosen using the DCI, or determined implicitly. For example, if the first RS is received in slot n, the 2^{nd} RS may need to be transmitted in slot n+X, where X may be pre-defined (in a standard specification), determined based on UE capability, or explicitly configured (e.g., via MAC-CE, PC5 signaling, and/or in the SCI codepoint).

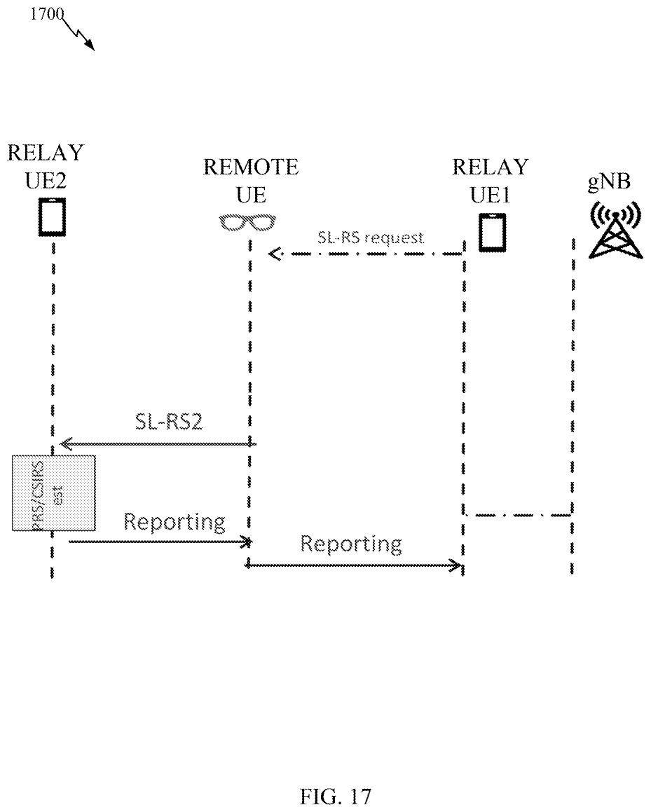

As illustrated in FIG. 17, in some cases, the recipient of the RS transmitted by the report UE may be different from the UE that triggered the SL-RS transmission. In the example illustrated in FIG. 17, a first relay UE (UE1) sends the SL-RS request triggering the SL-RS transmission from a remote UE to a second relay UE (UE2). Relay UE2 then generates a report (e.g., based on CSI/PRS estimation), which the remote UE forwards to relay UE1 (which may, in turn, forward the report to gNB).

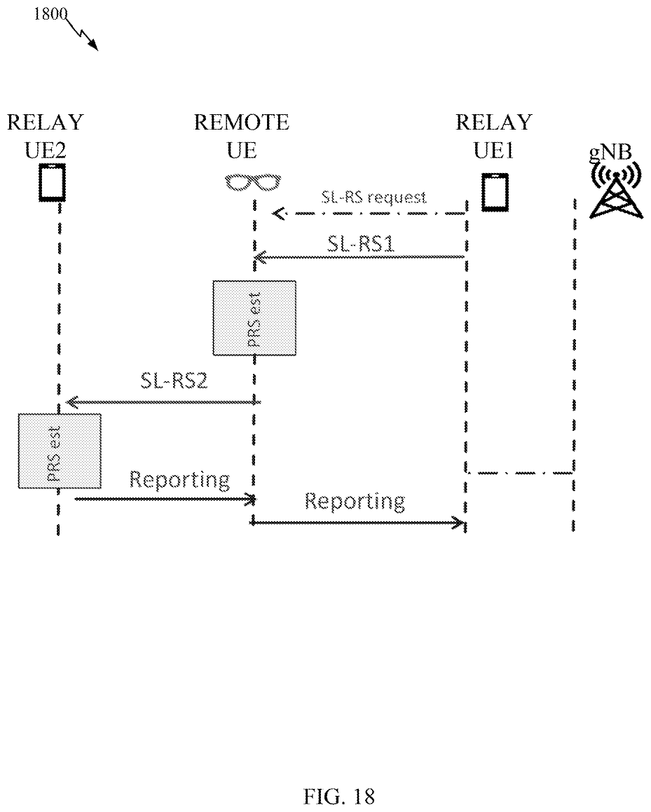

As illustrated in FIG. 18, relay UE1 may also send SL-RS (SL-RS1) to the remote UE, in accordance with parameters indicated in the SL-RS request. In such cases, the remote UE may process SL-RS1 (e.g., perform PRS estimation) prior to transmitting SL-RS2 to relay UE2. In such cases, the reporting from the remote UE to UE1 may include information generated based on SL-RS1 reception.

As noted above, FIG. 19 illustrates an example of positioning performed with a single BS and multiple relays, without Uu uplink signaling. In the illustrated example, reception of two SL-RS (from UE Relay 1 and UE Relay 2) and reception of one DL-PRS (from gNB) may be jointly triggered. For example, UE Relay 1 may trigger the remote UE with a single SL-RS request to receive the multiple RS (SL RS and DL RS/PRS). In this example, SL-PRS1 from Relay 1 may have its own beam information or Tx power information (indicated in the SL-RS request). Similarly, SL-PRS2 from Relay 2 and the DL-PRS from the gNB may each have their own beam information or Tx power information. Based on these reference signals, the remote UE may perform positioning measurements/estimates using any suitable algorithm. The remote UE may then report the results to the gNB (e.g., via one of the relay UEs).

By providing independent power and quasi co-location (QCL) information (e.g., spatial/beam control) information in an SL-RS request as described herein, aspects of the present disclosure may help increase channel estimation performance, reduce interference, and/or save power.

### Example Communications Devices

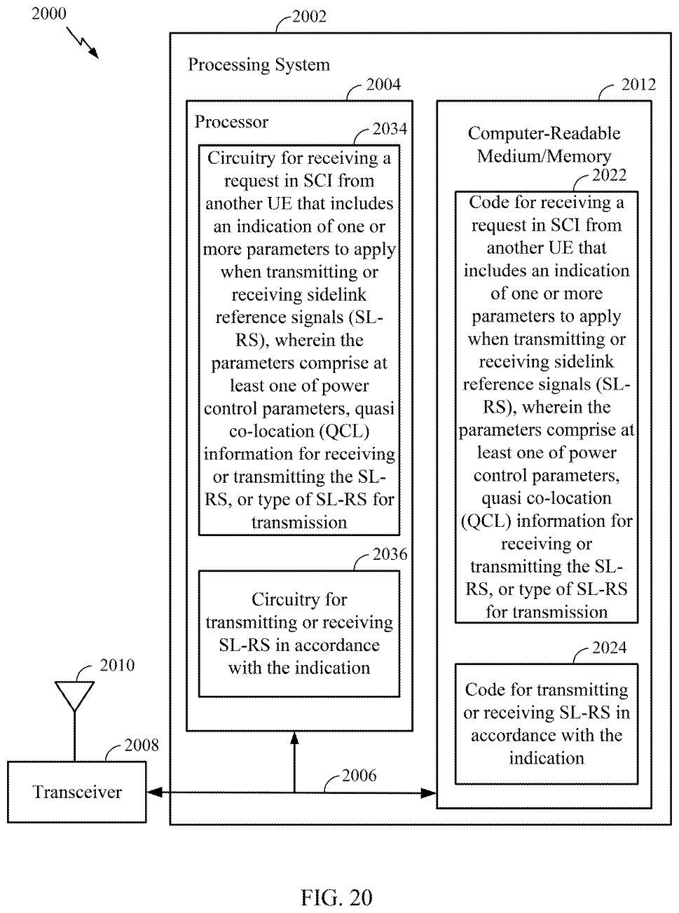

FIG. 20 illustrates a communications device 2000 that may include various components (e.g., corresponding to means-plus-function components) configured to perform operations for the techniques disclosed herein, such as the operations illustrated in FIG. 11. The communications device 2000 includes a processing system 2002 coupled to a transceiver 2008. The transceiver 2008 is configured to transmit and receive signals for the communications device 2000 via an antenna 2010, such as the various signals as described herein. The processing system 2002 may be configured to perform processing functions for the communications device 2000, including processing signals received and/or to be transmitted by the communications device 2000.

The processing system 2002 includes a processor 2004 coupled to a computer-readable medium/memory 2012 via a bus 2006. In certain aspects, the computer-readable medium/memory 2012 is configured to store instructions (e.g., computer-executable code) that when executed by the processor 2004, cause the processor 2004 to perform the operations illustrated in FIG. 11. In certain aspects, computer-readable medium/memory 2012 stores code 2022 for receiving a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and code 2024 for transmitting or receiving SL-RS in accordance with the indication.

In certain aspects, the processor 2004 has circuitry configured to implement the code stored in the computer-readable medium/memory 2012. The processor 2004 includes circuitry 2034 for receiving a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and circuitry 2036 for transmitting or receiving SL-RS in accordance with the indication.

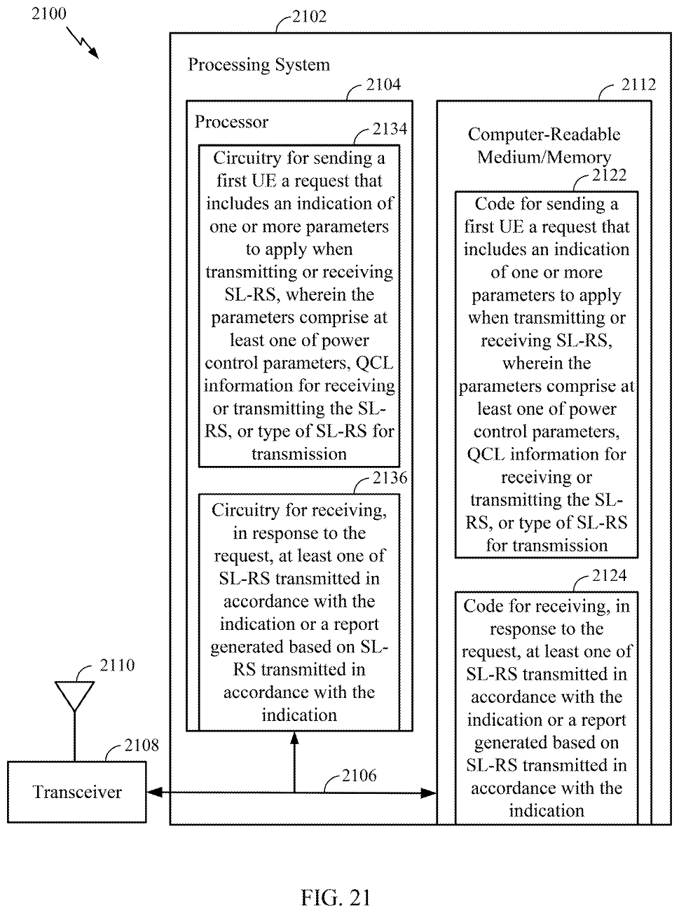

FIG. 21 illustrates a communications device 2100 that may include various components (e.g., corresponding to means-plus-function components) configured to perform operations for the techniques disclosed herein, such as the operations illustrated in FIG. 12. The communications device 2100 includes a processing system 2102 coupled to a transceiver 2108. The transceiver 2108 is configured to transmit and receive signals for the communications device 2100 via an antenna 2110, such as the various signals as described herein. The processing system 2102 may be configured to perform processing functions for the communications device 2100, including processing signals received and/or to be transmitted by the communications device 2100.

The processing system 2102 includes a processor 2104 coupled to a computer-readable medium/memory 2112 via a bus 2106. In certain aspects, the computer-readable medium/memory 2112 is configured to store instructions (e.g., computer-executable code) that when executed by the processor 2104, cause the processor 2104 to perform the operations illustrated in FIG. 12. In certain aspects, computer-readable medium/memory 2112 stores code 2122 for sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and code 2124 for receiving, in response to the request, at least one of SL-RS transmitted in accordance with the indication or a report generated based on SL-RS transmitted in accordance with the indication.

In certain aspects, the processor 2104 has circuitry configured to implement the code stored in the computer-readable medium/memory 2112. The processor 2104 includes circuitry 2134 for sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and circuitry 2136 for receiving, in response to the request, at least one of SL-RS transmitted in accordance with the indication or a report generated based on SL-RS transmitted in accordance with the indication.

### Example Aspects

Aspect 1: A method for wireless communications by a first user equipment (UE), comprising receiving a request in sidelink control information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and transmitting or receiving SL-RS in accordance with the indication.

Aspect 2: The method of Aspect 1, wherein the request is received in at least one of: a first stage SCI of a two stage SCI; or a second stage SCI of the two stage SCI.

Aspect 3: The method of any one of Aspects 1-2, further comprising: receiving signaling indicating different sets of transmission parameters, wherein the request includes a code point that selects one of the sets of transmission parameters to apply when transmitting or receiving the SL-RS.

Aspect 4: The method of Aspect 3, wherein: the request comprises a request for the UE to receive SL-RS from at least a second UE; and the code point selects a set of transmission parameters that includes transmit power information for the SL-RS transmitted from the second UE.

Aspect 5: The method of Aspect 3, wherein: the request comprises a request for the UE to transmit SL-RS to at least a second UE; and the code point selects a set of transmission parameters that includes one or more power control parameters to apply when transmitting the SL-RS to the second UE.

Aspect 6: The method of Aspect 3, wherein the code point maps to an identifier (ID) that selects the parameters from a configured table of parameters.

Aspect 7: The method of any one of Aspects 1-6, wherein the QCL information comprises at least one of spatial QCL information, delay, or Doppler information.

Aspect 8: The method of any one of Aspects 1-7, wherein the request includes a code point that maps to: a first set of one or more transmission parameters to apply for receiving a first SL-RS from a second UE; and a second set of one or more transmission parameters to apply for transmitting a second SL-RS to a third UE.

Aspect 9: The method of Aspect 8, wherein the second and third UEs are the same UE.

Aspect 10: The method of Aspect 8, wherein the first set of one or more transmission parameters comprises transmit power information for the first SL-RS.

Aspect 11: The method of Aspect 10, further comprising: measuring reference signal received power (RSRP) measurement for the received SL-RS; and calculating path loss based on the transmit power information and the RSRP measurement.

Aspect 12: The method of Aspect 8, further comprising determining a time gap between receiving the first SL-RS from the second UE and transmitting the second SL-RS to the third UE.

Aspect 13: The method of Aspect 12, wherein: a plurality of time gaps are configured to the UE, and one is chosen using sidelink control information (SCI) carrying the request or determined implicitly; or the time gap is determined based on capability reported by the UE or signaled via a medium access control (MAC) control element (CE), via a sidelink transmission.

Aspect 14: The method of any one of Aspects 1-13, wherein: transmitting or receiving SL-RS in accordance with the indication comprises transmitting SL-RS to a second UE; and the method further comprises receiving a report from the second UE based on the transmitted SL-RS.

Aspect 15: The method of any one of Aspects 1-14, wherein: transmitting or receiving SL-RS in accordance with the indication comprises receiving first SL-RS from a second UE and transmitting second SL-RS to a third UE; and the method further comprises receiving a report from the third UE based on the transmitted second SL-RS.

Aspect 16: The method of any one of Aspects 1-15, wherein: transmitting or receiving SL-RS in accordance with the indication comprises receiving at least first SL-RS from a first relay UE and at least one other RS; and the at least one other RS comprises at least one of a downlink RS from a base station or a second SL-RS from a second relay UE.

Aspect 17: The method of any one of Aspects 1-16, wherein the request indicates at least one of: a first set of one or more transmission parameters to apply for receiving the first SL-RS from the first relay UE; a second set of one or more transmission parameters to apply for receiving the second SL-RS from the second relay UE; and a third set of one or more transmission parameters to apply for receiving the downlink RS from the base station.

Aspect 18: A method for wireless communications by a wireless node, comprising: sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and receiving, in response to the request, at least one of SL-RS transmitted in accordance with the indication or a report generated based on SL-RS transmitted in accordance with the indication.

Aspect 19: The method of Aspect 18, wherein the wireless node comprises a relay UE.

Aspect 20: The method of any one of Aspects 18-19, wherein: the wireless node comprises a base station; and the request is sent to the first UE via a relay UE.

Aspect 21: The method of any one of Aspects 18-20, wherein: the request includes a code point that selects one of the sets of transmission parameters to apply when transmitting or receiving the SL-RS.

Aspect 22: The method of Aspect 21, wherein: the request comprises a request for the UE to receive SL-RS from at least a second UE; and the code point selects a set of transmission parameters that includes transmit power information for the SL-RS transmitted from the second UE.

Aspect 23: The method of Aspect 21, wherein: the request comprises a request for the UE to transmit SL-RS to at least a second UE; and the code point selects a set of transmission parameters that includes one or more power control parameters to apply when transmitting the SL-RS to the second UE.

Aspect 24: The method of Aspect 21, wherein the code point maps to an identifier (ID) that selects the parameters from a configured table of parameters.

Aspect 25: The method of any one of Aspects 18-24, wherein the QCL information comprises at least one of spatial QCL information, delay, or Doppler information.

Aspect 26: The method of any one of Aspects 18-25, wherein the request includes a code point that maps to: a first set of one or more transmission parameters for the first UE to apply for receiving a first SL-RS from a second UE; and a second set of one or more transmission parameters for the first UE to apply for transmitting a second SL-RS to a third UE.

Aspect 27: The method of Aspect 26, wherein the first set of one or more transmission parameters comprises transmit power information for the first SL-RS.

Aspect 28: The method of Aspect 27, wherein receiving, in response to the request, at least one of SL-RS transmitted in accordance with the indication or a report generated based on SL-RS transmitted in accordance with the indication comprises receiving a report with path loss calculated based on the transmit power information.

Aspect 29: The method of Aspect 28, further comprising determining a time gap between receiving the first SL-RS from the second UE and transmitting the second SL-RS to the third UE.

Aspect 30: The method of Aspect 29, wherein the time gap is configured, chosen using downlink control information (DCI), or determined implicitly.

Aspect 31: The method of Aspect 29, wherein the time gap is determined implicitly based on capability of the UE or signaled via a medium access control (MAC) control element (CE), via a sidelink transmission, or via a sidelink control information (SCI) code point.

Aspect 32: The method of any one of Aspects 18-31, wherein receiving, in response to the request, at least one of SL-RS transmitted in accordance with the indication or a report generated based on SL-RS transmitted in accordance with the indication comprises: receiving, from the first UE, a report generated by a second UE based on SL-RS transmitted by the first UE in accordance with the indication.

Aspect 33: The method of any one of Aspects 18-32, further comprising: transmitting first SL-RS to the first UE in accordance with the indication, wherein receiving, in response to the request, at least one of SL-RS transmitted in accordance with the indication or a report generated based on SL-RS transmitted in accordance with the indication comprises receiving, from the first UE, a report generated by a second UE based on second SL-RS transmitted by the first UE in accordance with the indication.

Aspect 34: The method of any one of Aspects 18-33, wherein: the request triggers the first UE to receive at least first SL-RS from a first relay UE and at least one other RS.

Aspect 35: The method of Aspect 34, wherein that at least one other RS comprises at least: a second SL-RS from a second relay UE; and a downlink RS from a base station.

Aspect 36: The method of any one of Aspects 18-35, wherein the request indicates at least one of: a first set of one or more transmission parameters to apply for receiving the first SL-RS from the first relay UE; a second set of one or more transmission parameters to apply for receiving the second SL-RS from the second relay UE; and a third set of one or more transmission parameters to apply for receiving the downlink RS from the base stationAspect 1: TO BE COMPLETED UPON APPROVAL

Aspect 37: An apparatus for wireless communication by a UE, comprising a memory and at least one processor coupled to the memory, the memory and the at least one processor being configured to perform any of the operations of Aspects 1-36.

Aspect 38: An apparatus for wireless communication by a UE, comprising means for performing any of the operations of Aspects 1-36.

Aspect 39: A computer readable medium having instructions stored thereon for performing any of the operations of Aspects 1-36.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a UE 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
at least one processor; and
memory coupled to the at least one processor, the memory comprising code executable by the at least one processor to cause the apparatus to:
receive a request in sidelink control information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and
transmit or receiving SL-RS in accordance with the indication.

2. The apparatus of claim 1, wherein the request is received in at least one of:
a first stage SCI of a two stage SCI; or
a second stage SCI of the two stage SCI.

3. The apparatus of claim 1, wherein the memory further comprises code executable by the at least one processor to cause the apparatus to:
receive signaling indicating different sets of transmission parameters, wherein the request includes a code point that selects one of the sets of transmission parameters to apply when transmitting or receiving the SL-RS.

4. The apparatus of claim 3, wherein:
the request comprises a request for the UE to receive SL-RS from at least a second UE; and
the code point selects a set of transmission parameters that includes transmit power information for the SL-RS transmitted from the second UE.

5. The apparatus of claim 3, wherein:
the request comprises a request for the UE to transmit SL-RS to at least a second UE; and
the code point selects a set of transmission parameters that includes one or more power control parameters to apply when transmitting the SL-RS to the second UE.

6. The apparatus of claim 3, wherein the code point maps to an identifier (ID) that selects the parameters from a configured table of parameters.

7. The apparatus of claim 1, wherein the QCL information comprises at least one of spatial QCL information, delay, or Doppler information.

8. The apparatus of claim 1, wherein the request includes a code point that maps to:
a first set of one or more transmission parameters to apply for receiving a first SL-RS from a second UE; and
a second set of one or more transmission parameters to apply for transmitting a second SL-RS to a third UE.

9. The apparatus of claim 8, wherein the second and third UEs are the same UE.

10. The apparatus of claim 8, wherein the first set of one or more transmission parameters comprises transmit power information for the first SL-RS.

11. The apparatus of claim 10, wherein the memory further comprises code executable by the at least one processor to cause the apparatus to:
measure reference signal received power (RSRP) measurement for the received SL-RS; and
calculate path loss based on the transmit power information and the RSRP measurement.

12. The apparatus of claim 8, wherein the memory further comprises code executable by the at least one processor to cause the apparatus to determine a time gap between receiving the first SL-RS from the second UE and transmitting the second SL-RS to the third UE.

13. The apparatus of claim 12, wherein:
a plurality of time gaps are configured to the UE, and one is chosen using sidelink control information (SCI) carrying the request or determined implicitly; or
the time gap is determined based on capability reported by the UE or signaled via a medium access control (MAC) control element (CE), via a sidelink transmission.

14. The apparatus of claim 1, wherein:
transmitting or receiving SL-RS in accordance with the indication comprises transmitting SL-RS to a second UE; and
the apparatus further comprises receiving a report from the second UE based on the transmitted SL-RS.

15. The apparatus of claim 1, wherein:
transmitting or receiving SL-RS in accordance with the indication comprises receiving first SL-RS from a second UE and transmitting second SL-RS to a third UE; and
the apparatus further comprises receiving a report from the third UE based on the transmitted second SL-RS.

16. The apparatus of claim 1, wherein:
transmitting or receiving SL-RS in accordance with the indication comprises receiving at least first SL-RS from a first relay UE and at least one other RS; and
the at least one other RS comprises at least one of a downlink RS from a base station or a second SL-RS from a second relay UE.

17. The apparatus of claim 1, wherein the request indicates at least one of:
a first set of one or more transmission parameters to apply for receiving the first SL-RS from the first relay UE;
a second set of one or more transmission parameters to apply for receiving the second SL-RS from the second relay UE; and
a third set of one or more transmission parameters to apply for receiving the downlink RS from the base station.

18. An apparatus for wireless communications, comprising:
at least one processor; and
memory coupled to the at least one processor, the memory comprising code executable by the at least one processor to cause the apparatus to:
send a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and
receive, in response to the request, at least one of SL-RS transmitted in accordance with the indication or a report generated based on SL-RS transmitted in accordance with the indication.

19. The apparatus of claim 18, wherein the wireless node comprises a relay UE.

20. The apparatus of claim 18, wherein:
the wireless node comprises a base station; and
the request is sent to the first UE via a relay UE.

21. The apparatus of claim 18, wherein:
the request includes a code point that selects one of the sets of transmission parameters to apply when transmitting or receiving the SL-RS.

22. The apparatus of claim 21, wherein:
the request comprises a request for the UE to receive SL-RS from at least a second UE; and
the code point selects a set of transmission parameters that includes transmit power information for the SL-RS transmitted from the second UE.

23. The apparatus of claim 21, wherein:
the request comprises a request for the UE to transmit SL-RS to at least a second UE; and
the code point selects a set of transmission parameters that includes one or more power control parameters to apply when transmitting the SL-RS to the second UE.

24. The apparatus of claim 21, wherein the code point maps to an identifier (ID) that selects the parameters from a configured table of parameters.

25. The apparatus of claim 18, wherein the QCL information comprises at least one of spatial QCL information, delay, or Doppler information.

26. The apparatus of claim 18, wherein the request includes a code point that maps to:
a first set of one or more transmission parameters for the first UE to apply for receiving a first SL-RS from a second UE; and
a second set of one or more transmission parameters for the first UE to apply for transmitting a second SL-RS to a third UE.

27. The apparatus of claim 26, wherein the first set of one or more transmission parameters comprises transmit power information for the first SL-RS.

28. The apparatus of claim 27, wherein receiving, in response to the request, at least one of SL-RS transmitted in accordance with the indication or a report generated based on SL-RS transmitted in accordance with the indication comprises receiving a report with path loss calculated based on the transmit power information.

29. The apparatus of claim 28, wherein the memory further comprises code executable by the at least one processor to cause the apparatus to determine a time gap between receiving the first SL-RS from the second UE and transmitting the second SL-RS to the third UE.

30. The apparatus of claim 29, wherein the time gap is configured, chosen using downlink control information (DCI), or determined implicitly.

31. The apparatus of claim 29, wherein the time gap is determined implicitly based on capability of the UE or signaled via a medium access control (MAC) control element (CE), via a sidelink transmission, or via a sidelink control information (SCI) code point.

32. The apparatus of claim 18, wherein receiving, in response to the request, at least one of SL-RS transmitted in accordance with the indication or a report generated based on SL-RS transmitted in accordance with the indication comprises:
receiving, from the first UE, a report generated by a second UE based on SL-RS transmitted by the first UE in accordance with the indication.

33. The apparatus of claim 18, wherein the memory further comprises code executable by the at least one processor to cause the apparatus to:
transmit first SL-RS to the first UE in accordance with the indication, wherein receiving, in response to the request, at least one of SL-RS transmitted in accordance with the indication or a report generated based on SL-RS transmitted in accordance with the indication comprises receiving, from the first UE, a report generated by a second UE based on second SL-RS transmitted by the first UE in accordance with the indication.

34. The apparatus of claim 18, wherein:
the request triggers the first UE to receive at least first SL-RS from a first relay UE and at least one other RS.

35. The apparatus of claim 34, wherein that at least one other RS comprises at least:
a second SL-RS from a second relay UE; and
a downlink RS from a base station.

36. The apparatus of claim 18, wherein the request indicates at least one of:
a first set of one or more transmission parameters to apply for receiving the first SL-RS from the first relay UE;
a second set of one or more transmission parameters to apply for receiving the second SL-RS from the second relay UE; and
a third set of one or more transmission parameters to apply for receiving the downlink RS from the base station.

37. A method for wireless communications by a first user equipment (UE), comprising:
receiving a request in sidelink control information (SCI) from another UE that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and
transmitting or receiving SL-RS in accordance with the indication.

38. A method for wireless communications by a wireless node, comprising:
sending a first user equipment (UE) a request that includes an indication of one or more parameters to apply when transmitting or receiving sidelink reference signals (SL-RS), wherein the parameters comprise at least one of power control parameters, quasi co-location (QCL) information for receiving or transmitting the SL-RS, or type of SL-RS for transmission; and
receiving, in response to the request, at least one of SL-RS transmitted in accordance with the indication or a report generated based on SL-RS transmitted in accordance with the indication.
